(19) United States
(12) Patent Application Publication
(10) Pub. No.: US 2016/0241610 A1
(43) Pub. Date: Aug. 18, 2016

(54) ADHOC GROUP CALL COMMUNICATIONS OVER EVOLVED MULTIMEDIA BROADCAST MULTICAST SERVICE

(71) Applicants: Xiaoxia ZHANG, San Diego, CA (US); Jun WANG, San Diego, CA (US); Xipeng ZHU, San Diego, CA (US); QUALCOMM INCORPORATED, San Diego, CA (US)

(72) Inventors: Xiaoxia ZHANG, San Diego, CA (US); Jun WANG, San Diego, CA (US); Xipeng ZHU, Beijing (CN)

(21) Appl. No.: 15/024,003

(22) PCT Filed: Oct. 29, 2014
(86) PCT No.: PCT/CN2014/089781

§ 371 Date: Mar. 22, 2016

(30) Foreign Application Priority Data
Oct. 30, 2013 (CN) PCT/CN2013/086209

(51) Int. Cl. H04L 29/06; H04W 72/04

(52) U.S. Cl. CPC H04L 65/403; H04L 65/4076; H04W 72/0446; H04W 84/18

(57) ABSTRACT

A network reserves a plurality of temporary mobile group identities (TMGIs). For each of the plurality of reserved TMGIs, the network establishes an evolved multimedia broadcast multicast service (eMBMS) session in at least one preconfigured multicast broadcast single frequency network (MBSFN) area. The network receives a request to form an adhoc group communications service enabler (GCSE) group including a plurality of target UEs; an assigns one of the plurality of TMGIs to the adhoc GCSE group.

### CROSS-REFERENCE TO RELATED APPLICATION(S)

This application claims the benefit of PCT International Application Serial No. PCT/CN2014/089781, entitled “Adhoc Group Call Communications Over Evolved Multimedia Broadcast Multicast Service” and filed on Oct. 29, 2014, which claims priority of PCT International Application Serial No. PCT/CN2013/086209, entitled “Adhoc Group Call Communications Over Evolved Multimedia Broadcast Multicast Service” and filed on Oct. 30, 2013, which are expressly incorporated by reference herein in their entirety.

### BACKGROUND

1. Field

The present disclosure relates generally to communication systems, and more particularly, to adhoc group call communications over evolved multimedia broadcast multicast service (eMBMS).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In one aspect, a network reserves a plurality of temporary mobile group identities (TMGIs). For each of the plurality of reserved TMGIs, the network establishes an evolved multimedia broadcast multicast service (eMBMS) session in at least one preconfigured multicast broadcast single frequency network (MBSFN) area. The network receives a request to form an adhoc group communications service enabler (GCSE) group including a plurality of target UEs; an assigns one of the plurality of TMGIs to the adhoc GCSE group.

In another aspect, a network receives a request to form an adhoc GCSE group including a plurality of target UEs. The network sets up an eMBMS session for the plurality of target UEs based on a MCCH having a MCCH configuration parameter different from a corresponding MCCH configuration parameter for non adhoc GCSE group UEs.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIG. 8 is a diagram illustrating an example of a network architecture including a group communication system enabler application server (GCSE-AS).

FIG. 9 is a call flow diagram illustrating a procedure for an adhoc group call over dynamic eMBMS session setup.

FIG. 10 is a call flow diagram illustrating the procedure of adhoc group call over eMBMS session for the proposal.

FIG. 11 is a flow chart of a method of wireless communication.

FIG. 12 is a conceptual data flow diagram illustrating the data flow between different modules/means/components in an exemplary apparatus.

FIG. 13 is a diagram illustrating an example of a hardware implementation for an apparatus employing a processing system.

FIG. 14 is a diagram illustrating a MCCH transmission time line.

FIG. 15 is a flow chart of a method of wireless communication.

FIG. 16 is a conceptual data flow diagram illustrating the data flow between different modules/means/components in an exemplary apparatus.

FIG. 17 is a diagram illustrating an example of a hardware implementation for an apparatus employing a processing system

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

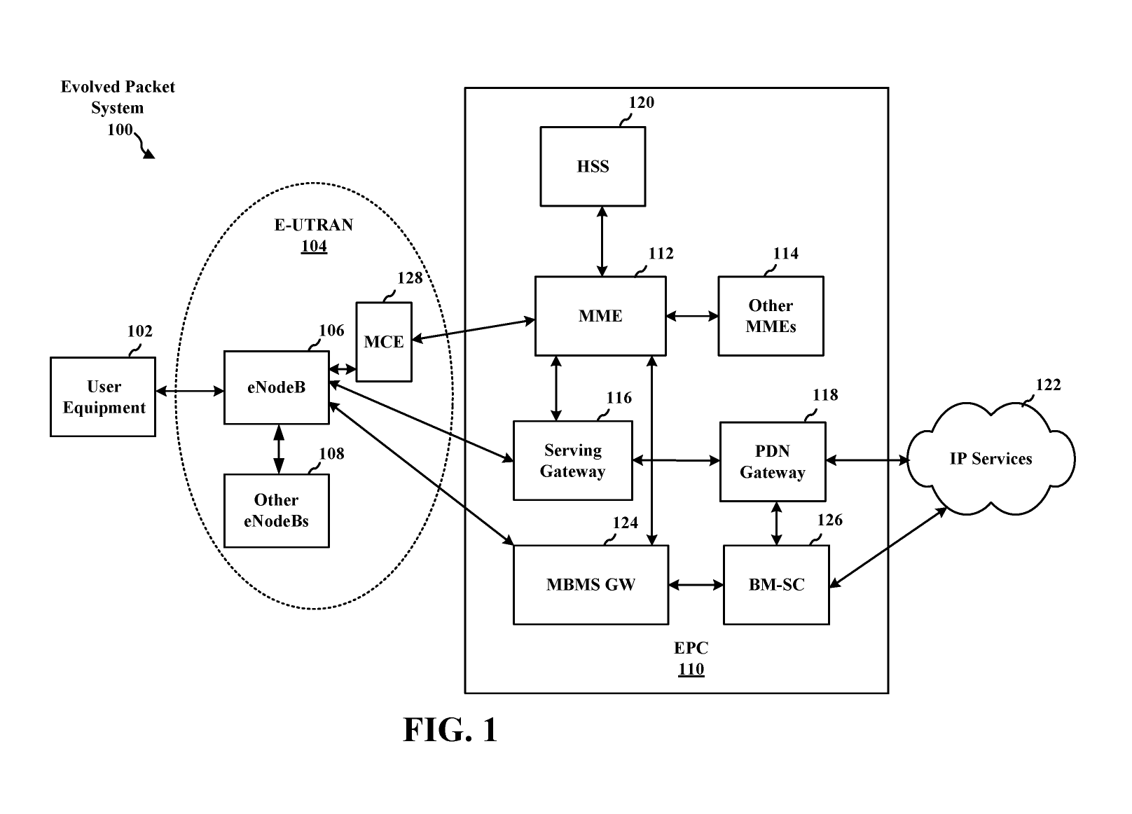

FIG. 1 is a diagram illustrating a LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

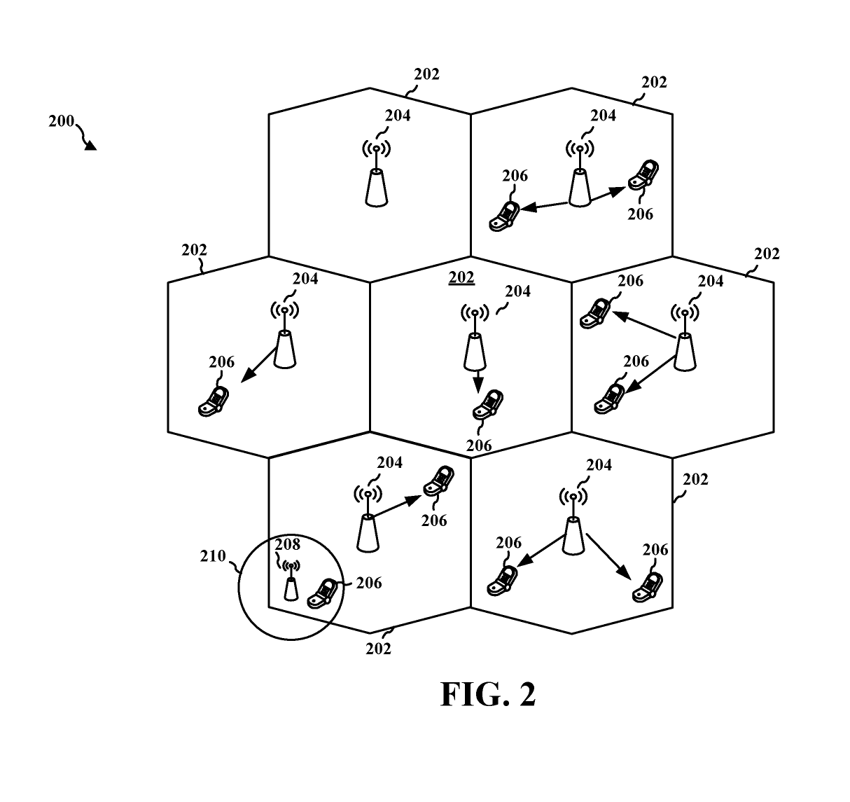

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

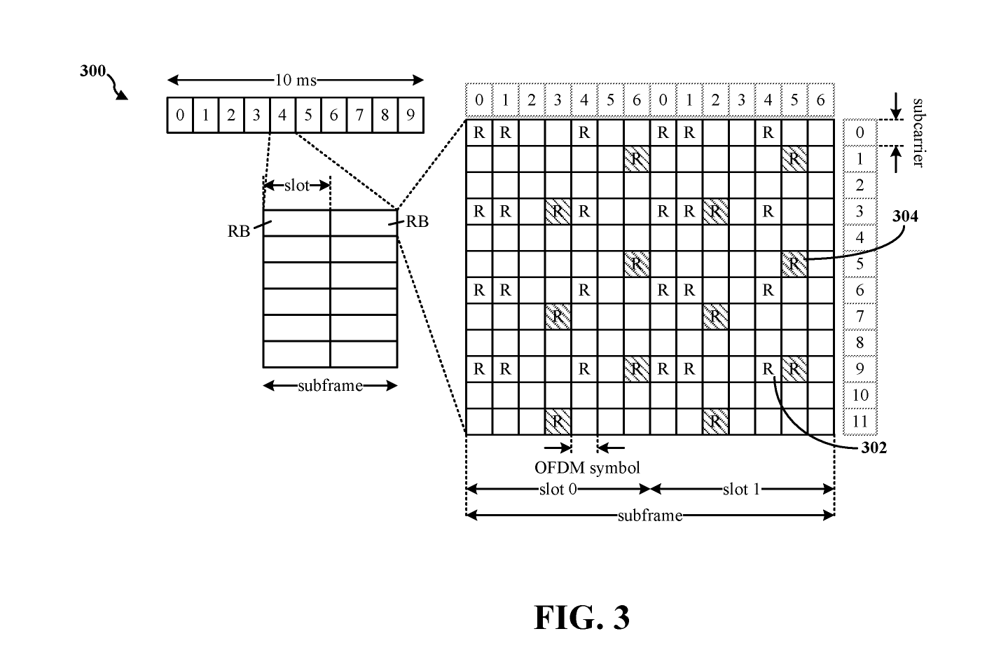

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

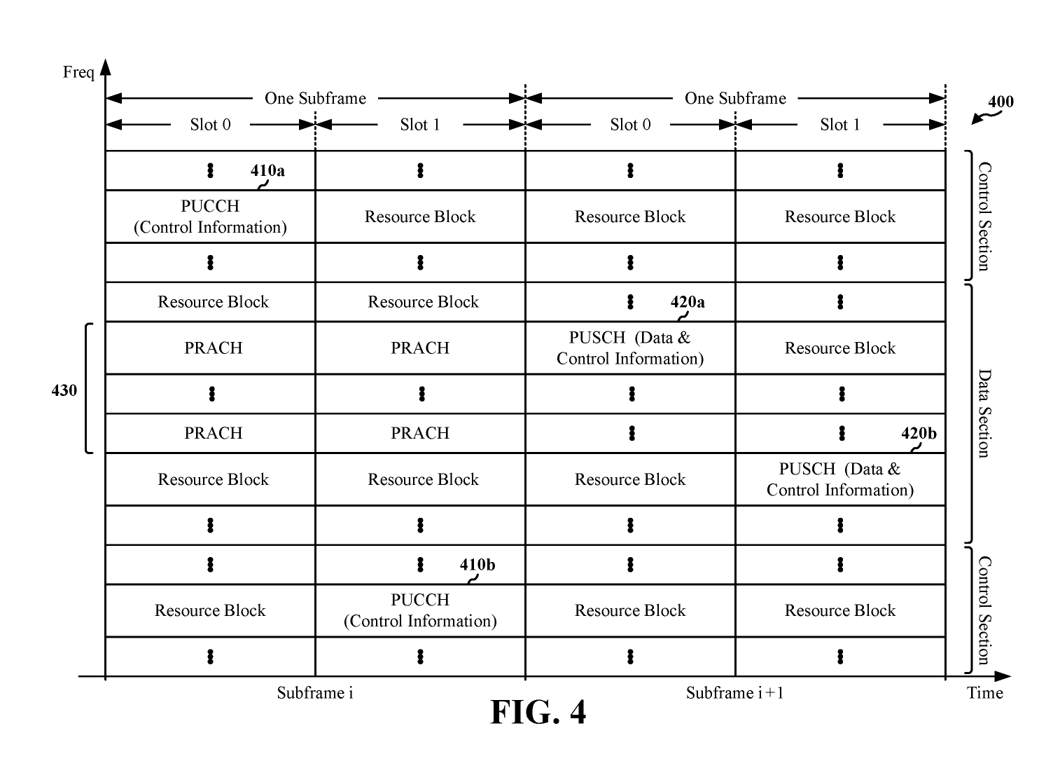

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

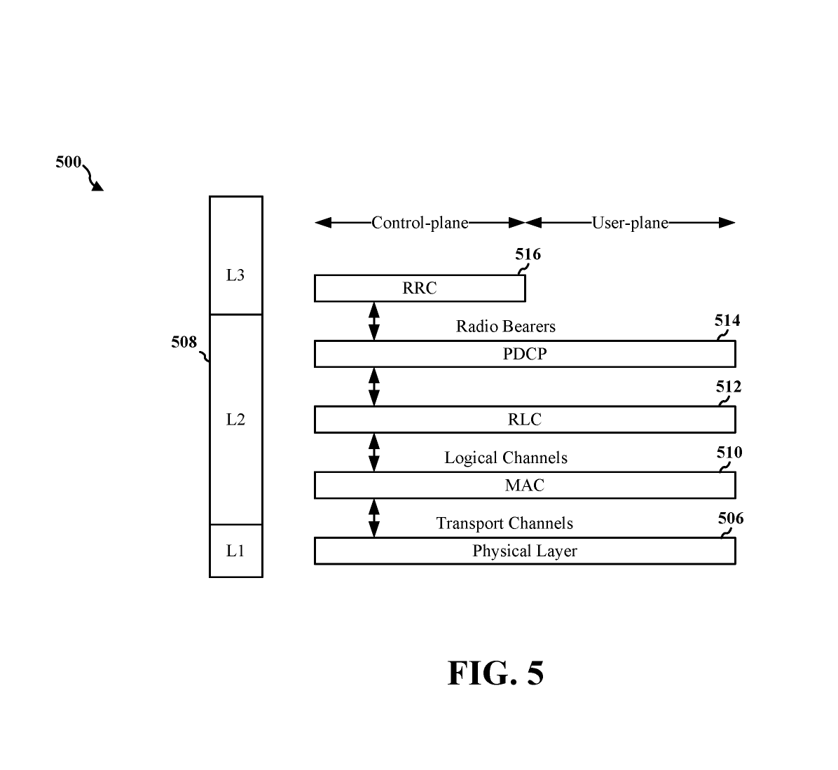

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

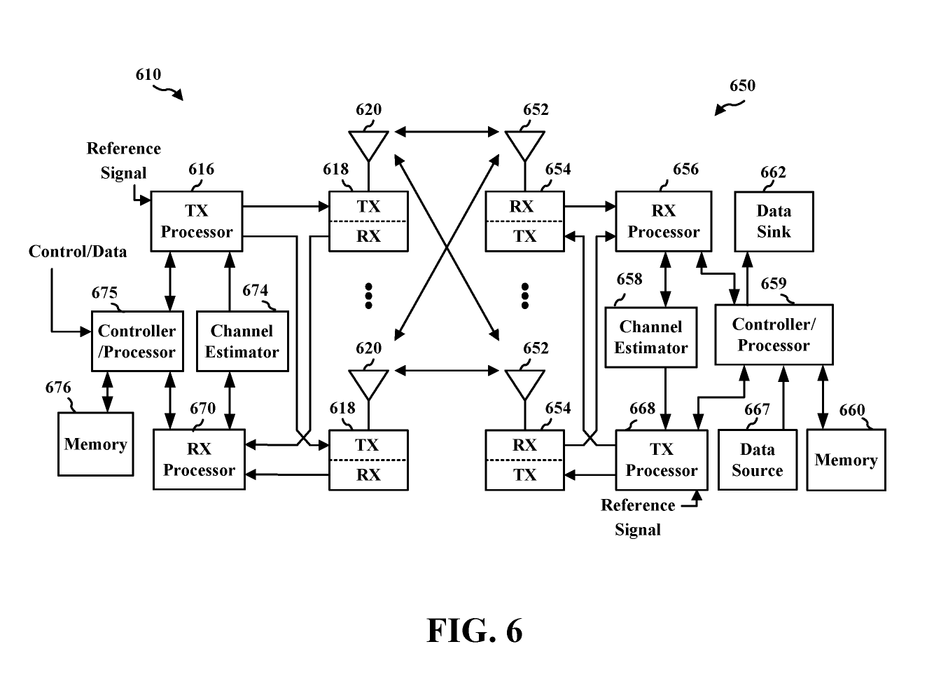

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

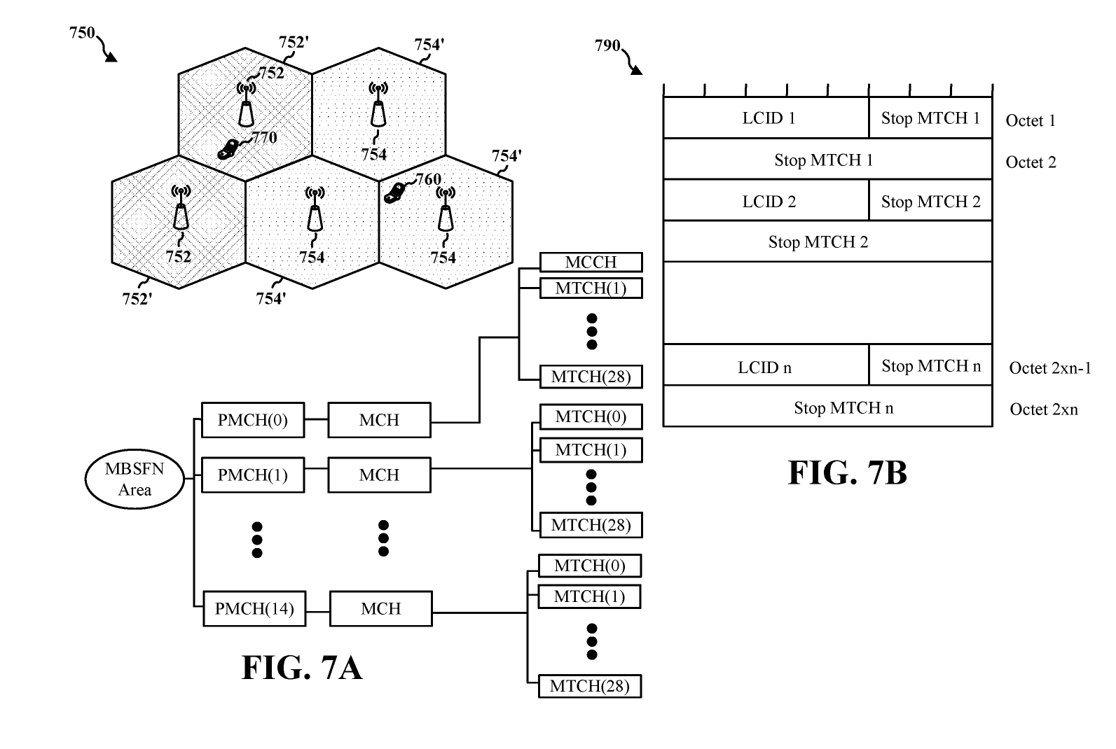

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 may indicate (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted. A TMGI is a unique identifier of an eMBMS service, composed of an eMBMS service ID and a PLMN ID.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

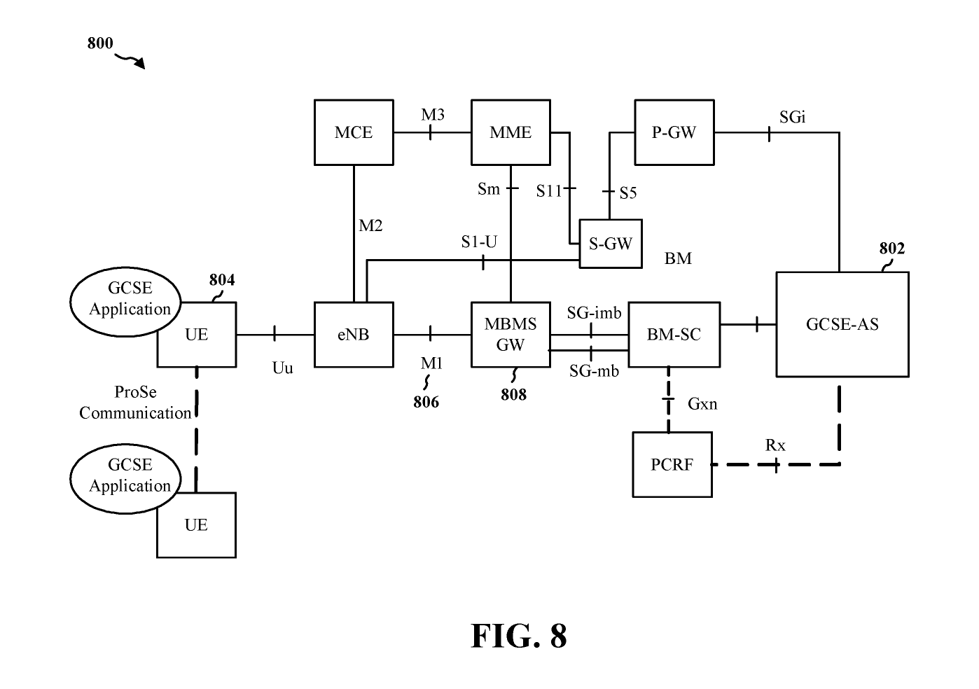

FIG. 8 is a diagram 800 illustrating an example of a network architecture including a group communication system enabler application server (GCSE-AS) 802. A GCSE-AS 802 is a 3GPP feature enabling an application layer functionality to provide group communication over E-UTRAN. A group communication service is intended to provide a fast and efficient mechanism to distribute the same content, to multiple users in a controlled manner through “group communication.” Group communication corresponds to communication from transmitter group members to receiver group members. A “transmitter group member” is a group member of a GCSE group that is authorized to transmit an ongoing or future group communications for that GCSE group. A “receiver group member” is a group member of a GCSE group that has interest expressed in receiving ongoing or future group communications of that GCSE group. As an example, the concept of group communications is used extensively in the operation of classical Land Mobile Radio (LMR) systems used for, but not limited to, public safety organizations.

In existing group communications setups, a potential participant UE in a group call may be preassigned a TMGI for a group service of which the UE is one or both of a transmitter group member or receiver group member. Preassigned in this regard means that the UE receives the TMGI and stores the TMGI for future use in identifying a schedule or ongoing group call. A group call may be preconfigured in that the participant UEs are known, one or more TMGIs are pre-assigned to the UE, and the eMBMS bearers associated with the pre-assigned TMGIs are pre-configured on the network side. The MCCH associated with the MBSFN area in which the group call may occur has the TMGI listed. As such, a participant UE monitors the multicast channel scheduling information (MSI) to identify whether an eMBMS service of interest uniquely identified by, and thereby corresponding to, a pre-assigned TMGI is currently scheduled.

In the case of adhoc group communications, there is no preassignment of TMGIs and no preconfiguration of eMBMS bearers. Instead, participant UEs are selected and an eMBMS session is started on an adhoc basis. The network may provide a mechanism for the dynamic creation, modification, and deletion of adhoc GCSE groups.

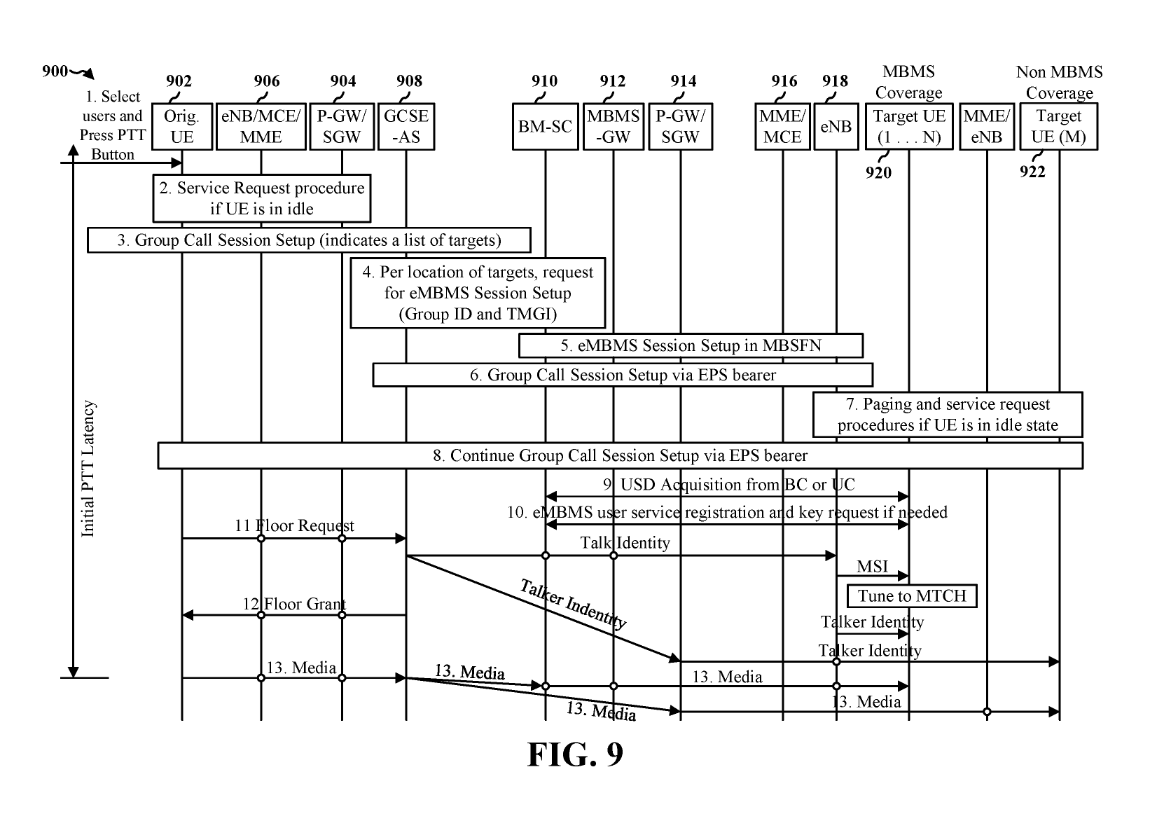

FIG. 9 is a call flow diagram illustrating a procedure for an adhoc group call over dynamic eMBMS session setup. At step 1, a first user selects a number of other users, e.g., participants, to include in an adhoc GCSE group. The selection of participants may be made through a graphical user interface (GUI) of a UE 902. In this regard, the UE 902 functions as a GCSE originator. Upon completion of participant selection, the first user may initiate further group call set up by, for example, pressing a push-to-talk button of the GUI.

At step 2, if the UE 902 is in an RRC IDLE state, the UE sends a service request to the P-SW/S-GW 904 to enter the RRC CONNECTED state. Entry into the RRC CONNECTED state is performed using known procedures. Once in the RRC CONNECTED state, the UE 902 may send a message to further initiate group call session setup. If the UE is already in an RRC CONNECTED state, the call flow may proceed directly to step 3.

At step 3, network elements, including the eNB/MCE/MME 906, the P-GW/S-GW 904, and the GCSE-AS 908, execute a group call session setup. To this end, the UE 902 sends a message, e.g., SIP message, to the GCSE-AS 908 that includes a list of targets corresponding to the participants identified by the first user to be included in the adhoc GCSE group.

At step 4, the GCSE-AS 908 determines the location of each of the target UEs based on location information received from the UE. If all the targets are generally in the same location, the GCSE-AS 908 transmits a request to the BM-SC 910 to set up the eMBMS session. The request from the GCSE-AS 908 includes a group ID. The BM-SC 910 assigns a TMGI to the group ID and sends it to the GCSE-AS 910. If a target is located in a different area from the other targets, the GCSE-AS 908 will trigger a unicast channel setup with the P-GW 914. The GCSE-AS 908 may obtain the location of the target UEs via existing location service (LCS) procedures or may act as an Application Function in requesting the UE's location from the policy and charging rules function (PCRF) or home subscriber server (HSS). The GCSE-AS 908 may pass the UE's location information (for example, service area, cell ID etc) to the BM-SC 910 and the BM-SC can determine a MBMS service area and MBSFN areas for the service. In accordance with current 3GPP specification, MBMS service areas and MBSFN areas can be preconfigured via operation and maintenance (O&M). Alternatively, MBMS service areas and MBSFN areas may be dynamically established based on UE's location.

At step 5, the BM-SC 910 sets up the eMBMS broadcast session in the appropriate MBSFN areas using signalling through the MBMS-GW 912 to the MME/MCE 916 to the eNB 918. User plane signalling goes from the BM-SC 910 through the MBMS-GW 912 to the eNB 918.

Typically, the time to complete an MBMS session setup (step 4 and step 5) is longer than other steps because of the MCCH modification period, which may be between 5 and 10 seconds. When MCCH is modified due to, for example, an MBMS session start or MBMS counting request message, the network notifies the UE of the modification. The notification is sent periodically throughout the modification period preceding the change of MCCH. Upon receipt of a MCCH change notification, the UE waits for the beginning of the next MCCH modification period to monitor for the changes.

At step 6, the GCSE-AS 908 continues the group call session setup of step 3. To this end, the GCSE-AS 908 sends a group call session setup message to the eNB 918 through the P-GW/SGW 904 and the MME 906. The message identifies the target UEs (or participant UEs) and requests the eNB 918 to initiate communication with the target UEs over unicast channel via an EPS bearer through the eNB 918.

At step 7, for each of the target UEs, the MME/eNB 918 determines if the UE is in an RRC IDLE state. For those target UEs that are in RRC IDLE, the MME and eNB 918 initiates a paging and service request procedure for that target UE, to cause the target UE to enter the RRC CONNECTED STATE.

At step 8, the group call session setup of steps 6 and 7 is continued until each target UE has either been successfully added to the group or removed from the target group due to, for example, failure to locate.

At step 9, target UEs within eMBMS coverage perform a user service description (USD) acquisition. The USD may be obtained through unicast or broadcast. Based on information included in the USD, the target UE is able to listen to the eMBMS session.

At step 10, if the USD indicates the registration is required, the UE performs eMBMS user service registration and key request, if needed.

At step 11, a user makes a floor request (a request to talk) by sending a request from the originating UE 902 to the GCSE-AS 908. The GCSE-AS 908 sends the identity of the user making the floor request to the BM-SC 910 (for the target UEs in the MBMS coverage) and to the P-GW 914 (for the target UEs not in the MBMS coverage) and provides the identity to other participants, e.g., targets UEs, in the adhoc GCSE group. For target UEs within eMBMS coverage 920, talker identity is provided by the GCSE-AS 908 through the BM-SC 910 to the MBMS-GW 912 and the eNB 918. In this case the target UEs 920 listen to the MSI, check the TMGI associated with the group call, determine the MTCH of the group call, and tunes to the determined MTCH to receive the talker identity. For target UEs outside of eMBMS coverage 922, talker identity is provided by the GCSE-AS 908 through the P-GW/S-GW 914 and the eNB 918 via unicast.

At step 12, the GCSE-AS 908 grants the floor to the originating UE 902. Upon receipt of the floor grant, media may be communicated from the originating UE 902 to the target UEs 920, 922.

At step 13, the originating UE 902 sends media to the target UEs 920, 922. Media may include conversational type communications media (e.g., voice, video) or streaming media (e.g. video) or data media (e.g. messaging, file download) or a combination of the various media. For target UEs within MBMS coverage 920, media sent from the originating UE 902 is received via signaling through the GCSE-AS 908, the BM-SC 910, the MBMS-GW 912 and the eNB 918. For target UEs outside of MBMS coverage 922, media sent from the originating UE 902 is received via signaling through the GCSE-AS 908, the P-GW/S-GW 914 and the eNB 918.

The following table 1 represents the time or latency between step 2 and step 12 of the flow call of FIG. 9.

TABLE 1

| | | Average | |
|---|---|---|---|
| Step | | Time | |
| Number | Description | (ms) | Comments |
| 2 | Service Request | 140 | 80 ms for random access; 60 ms |
| | Procedures | | for the rest of the steps, |
| | | | including RRC connection |
| | | | setup/service request, security |
| | | | command, RRC |
| | | | reconfiguration. |
| 3 | Group call session | 50 | Sending group call setup |
| | setup | | signaling (e.g., SIP Invite) |
| 4 and 5 | MBMS Session | 5120 or | MCCH modification period is |
| | Setup | 1024 | 5.12 s or 10.24 s |
| 6 | Continue Group call | 50 | SIP messages |
| | setup via EPS bearer | | |
| 7 | Paging and Service | 140 | Paging is not counted. 140 only |
| | Request Procedures | | includes listeners RRC Setup |
| | to targets | | |
| 8 | Continue Group call | 50 | SIP messages |
| | setup | | |
| 9 | USD Update | 0 | In parallel with MMS session |
| | | | setup |
| 10 | MBMS user service | 0 | In parallel with MMS session |
| | registration and key | | setup |
| | request | | |
| 11 | MSP (Read MSI) | 40 | MCH Schedule Period is from |
| | | | 8 frame to 1024 frames |
| 12 | Floor Permit | 20 | Talk Burst Confirm |
| | Total latency | 5510 or | |
| | | 10630 | |

An issue with the forgoing dynamic eMBMS session setup is that it may not meet the call setup delay requirement for acceptable group communication. More specifically, as shown in table 1, the time between a user pushing to talk and initiating a service request procedure (step 2) and being granted the floor (step 12) may take between 5 and 10 seconds. This amount of time can result in a poor user experience when participating in the group call communication.

Disclosed below are several options that can reduce the setup delay for group call communication. In a first option, a pool of TMGIs (e.g., TMGI1 to TMGIₙ) for different adhoc groups with corresponding preestablished eMBMS sessions is reserved. A second option introduces a new MCCH used only for group calls. The new MCCH has a reduced MCCH modification period, a reduced repetition period and/or a reduced change notification period, relative to periods as provided in current 3GPP specifications. A third option reduces the modification period, repetition period and change notification period of the existing MCCH associated with the MBSFN area associated with the group communication.

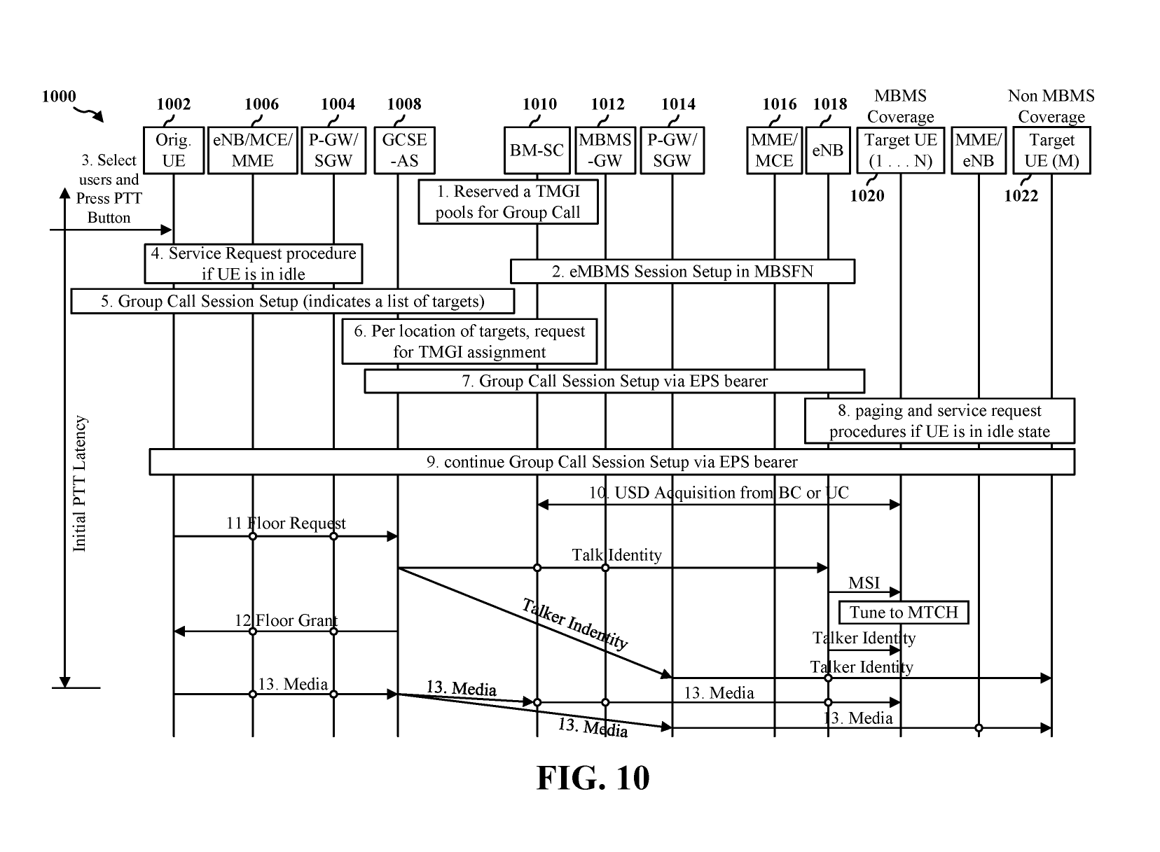

FIG. 10 is a call flow diagram illustrating the procedure of adhoc group call over eMBMS session for the first option. In this procedure, eMBMS session setup is done in advance of formation of an adhoc group communication setup. To this end, at step 1, the BM-SC 1010 reserves a pool of TMGIs (e.g., TMGI1 to TMGIₙ) for different adhoc groups. In some cases the pool of TMGIs may include only one TMGI. The TMGI pool may be maintained in the BM-SC 1002.

At step 2, for each TMGI in the TMGI pool, the BM-SC 1010 establishes or sets up an eMBMS session with the eNB 1018. Each pre-established eMBMS session corresponds to a preconfigured MBSFN area. The MCCH associated with the MBSFN area contains all corresponding TMGIs available in the MBSFN area. and eMBMS session information, including MBSFN subframe allocations.

At step 3, a first user selects a number of other users, e.g., participants, to include in an adhoc GCSE group. The selection of participants may be made through a GUI of a UE 1002. In this regard, the UE 1002 functions as a GCSE originator. Upon completion of participant selection, the first user may initiate further group call set up by, for example, pressing a push-to-talk button of the GUI.

At step 4, if the UE 1002 is in an RRC IDLE state, the UE sends a service request to the P-SW/S-GW 1004 to enter the RRC CONNECTED state. Entry into the RRC CONNECTED state is performed using known procedures. Once in the RRC CONNECTED state, the UE 1002 may send a message, e.g., SIP message, to the GCSE-AS 1008 that includes a list of targets corresponding to the participants identified by the first user to be included in the adhoc GCSE group, to further initiate group call session setup. If the UE is already in an RRC CONNECTED state, the call flow may proceed directly to step 5.

At step 5, network elements, including the eNB/MME 1006, the P-GW/S-GW 1004, and the GCSE-AS 1008, execute a group call session setup. To this end, the UE 1002 sends a message to the GCSE-AS 1008 that includes a list of target UEs corresponding to the participants to be included in the adhoc GCSE group.

At step 6, the GCSE-AS 1008 determines the location of each of the target UEs based on location information received from the UE. The GCSE-AS 1008 may obtain the location of the target UEs via existing LCS procedures or may act as an Application Function in requesting the UE's location from the PCRF or HSS. If all target UEs are generally in the same location, the GCSE-AS 908 sends a request to the BM-SC 1010 for a TMGI assignment. The request includes the locations of the target UEs. The BM-SC 1010 uses the location information to determine a TMGI from the pool of available TMGIs that uniquely identifies an established eMBMS session in an MBSFN area that covers the locations of the target UEs. If a target UE is located in a different area from others, the GCSE-AS 908 will trigger a unicast channel setup with the P-GW 914 for that target UE.

At step 7, the GCSE-AS 1008 continues the group call session setup of step 5. To this end, the GCSE-AS 1008 sends a group call session setup message to the eNB 1018. The message identifies the target UEs and requests the eNB 918 to initiate communication with the target UEs over unicast via an EPS bearer through the eNB.

At step 8, for each of the target UEs, the eNB 1018 determines if the UE is in an RRC IDLE state. For those target UEs that are in RRC IDLE, the eNB 1018 initiates a paging and service request procedure for that target UE, to cause the target UE to enter the RRC CONNECTED STATE.

At step 9, the group call session setup of steps 7 and 8 is continued until each target UE has either been successfully added to the group or removed from the target group due to, for example, failure to locate.

At step 10, a target UE within eMBMS coverage receives a user service description (USD) acquisition. To this end, the UE may receive a USD over an MBMS bearer if the USD is broadcast. Otherwise, the UE may perform a unicast query to obtain the USD from a unicast channel. The USD may be obtained via a unicast channel or a broadcast channel. Based on information included in the USD, the target UE is able to listen to the MBMS session. More specifically, the USD indicates the USD indicates that the adhoc GCSE group call is enabled through an MBMS session. The USD also indicates the TMGI of the pool of TMGIs corresponding to the service.

At step 11, a user makes a floor request (a request to talk) by sending a request from the originating UE 1002 to the GCSE-AS 1008. The GCSE-AS 1008 varies the identity of the user making the floor request and provides the identity to other participants, e.g., target UEs, in the adhoc GCSE group. For target UEs within MBMS coverage 1020, talker identity is provided by the GCSE-AS 1008 through the BM-SC 1010, the MBMS-GW 912 and the eNB 1018. In this case the target UEs 1020 listen to the MSI, check the TMGI associated with the group call, determine the MTCH of the group call, and tune to the determined MTCH to receive the talker identity. For target UEs outside of MBMS coverage 1022, talker identity is provided by the GCSE-AS 1008 through the P-GW/S-GW 1014 and the eNB 1018 via respective unicast channels.

At step 12, the GCSE-AS 1008 grants the floor to the originating UE 1002. Upon receipt of the floor grant, media may be communicated from the originating UE 1002 to the target UEs 1020, 1022.

At step 13, the originating UE 1002 sends media to the target UEs 1020, 1022. Media may include conversational type communications media (e.g., voice, video) or streaming media (e.g. video) or data media (e.g. messaging, file download) or a combination of the various medium. For target UEs within MBMS coverage 1020, media from the originating UE 1002 is received via signaling through the GCSE-AS 1008, the BM-SC 1010, the MBMS-GW 1012 and the eNB 1018. For target UEs outside of MBMS coverage 1022, media is received via signaling through the GCSE-AS 1008, the P-GW/S-GW 1014 and the eNB 1018.

If there is no group call data to be transmitted or if the group call data does not need all the allocated MBSFN subframes in the current radio frame, the subframe(s) configured for MBSFN in the current radio frame can be reused for transmission mode 9 (TM9) and TM10 unicast transmissions. The GCSE-AS 1008 obtains a TMGI from the BM-SC 1002 when the adhoc group is established. The BM-SC 1010 assigns an unused TMGI from the TMGI pool. The assigned TMGI may be reused for another group call after the current group call is completed. Different groups may also share the same TMGI and different IP ports can be used to distinguish the different groups. The MSI may be modified accordingly when the eNB 1018 receives the group call data from the MBMS-GW 1012 for the corresponding TMGI.

The following table 2 represents the time or latency between step 4 and step 12 of the flow call of FIG. 10. The total latency is 610 ms, as opposed to the total latency of 5510 or 10630 ms of the call flow of FIG. 9. The reduction in latency is due to the pre-configuration of MBMS sessions which allows for the elimination of the MBMS session setup (steps 4 and 5) of the process of FIG. 9.

TABLE 2

| | | Average | |
|---|---|---|---|
| Step | | Time | |
| Number | Description | (ms) | Comments |
| 4 | Service Request | 140 | 80 ms for random access; 60 ms |
| | Procedures | | for the rest of the steps, |
| | | | including RRC connection |
| | | | setup/service request, security |
| | | | command, RRC |
| | | | reconfiguration. |
| 5 | Group call session | 50 | Sending group call setup |
| | setup | | signaling (e.g., SIP Invite) |
| 6 | Request for TMGI | 20 | MCCH modification period is |
| | assignment | | 5.12 s or 10.24 s |
| 7 | Continue Group call | 50 | SIP messages |
| | setup via EPS bearer | | |
| 8 | Paging and Service | 140 | Paging is not counted. 140 only |
| | Request Procedures | | includes listeners RRC Setup |
| | to targets | | |
| 9 | Continue Group call | 50 | SIP messages etc. |
| | setup | | |
| 10 | USD Update | 100 | In parallel with MMS session |
| | | | setup |
| 11 | MSP (Read MSI) | 40 | MCH Schedule Period is from |
| | | | 8 frame to 1024 frames |
| 12 | Floor Permit | 20 | Talk Burst Confirm |
| | Total latency | 610 | |

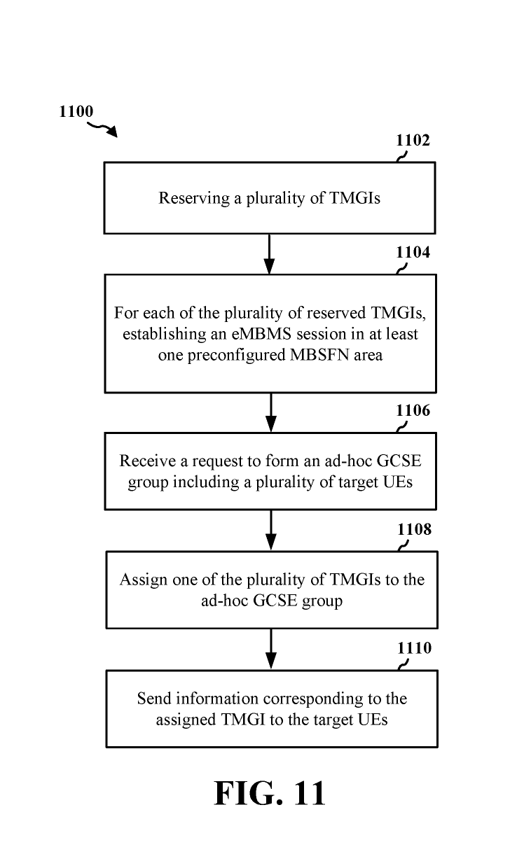

FIG. 11 is a flow chart 1100 of a method of wireless communication. The method may be performed by a network entity, such as a BM-SC, or a combination of network entities. At step 1102, the network entity reserves a plurality of TMGIs. To this end, the network entity may allocate a plurality of TMGIs as designated reserved TMGIs.

At step 1104, for each of the plurality of reserved TMGIs, the network entity establishes an eMBMS session in at least one preconfigured MBSFN area. To this end, the network entity may configure at least one eMBMS bearer for the eMBMS session; allocate MBSFN subframes to the eMBMS session; in the absence of group communication data for the adhoc GCSE group, reallocate MBSFN subframes allocated to the eMBMS session corresponding to the assigned TMGI, for unicast transmission; and configure the MCCH associated with the MBSFN area to include one or more reserved TMGIs and corresponding eMBMS session information. Corresponding eMBMS session information may include, for example, the information in a PMCH-InfoList in accordance with 3GPP TS. 331. This list specifies configuration of all PMCHs of an MBSFN area. The information provided for an individual PMCH includes the configuration parameters of the sessions that are carried by the concerned PMCH.

At step 1106, the network entity receives a request to form an adhoc group GCSE group including a plurality of target UEs.

At step 1108, the network entity assigns one of the plurality of TMGIs to the adhoc GCSE group. Assigning a TMGI may include determining the location of the target UEs, and selecting an unused one of the plurality of reserved TMGIs based on the location of the target UEs. For example, the network entity may identify a preconfigured MBSFN area that encompasses the target UEs, and assign the reserved TMGI that is associated with the identified MBSFN area.

At step 1110, the network sends information corresponding to the assigned TMGI to the target UEs.

The network entity may configure the MCCH of the MTCH configuration to include one or more reserved TMGIs and corresponding eMBMS session information. In the absence of group communication data for the adhoc GCSE group, the network entity may reallocate MBSFN subframes currently allocated to the eMBMS session corresponding to the selected reserved TMGI, for unicast transmission.

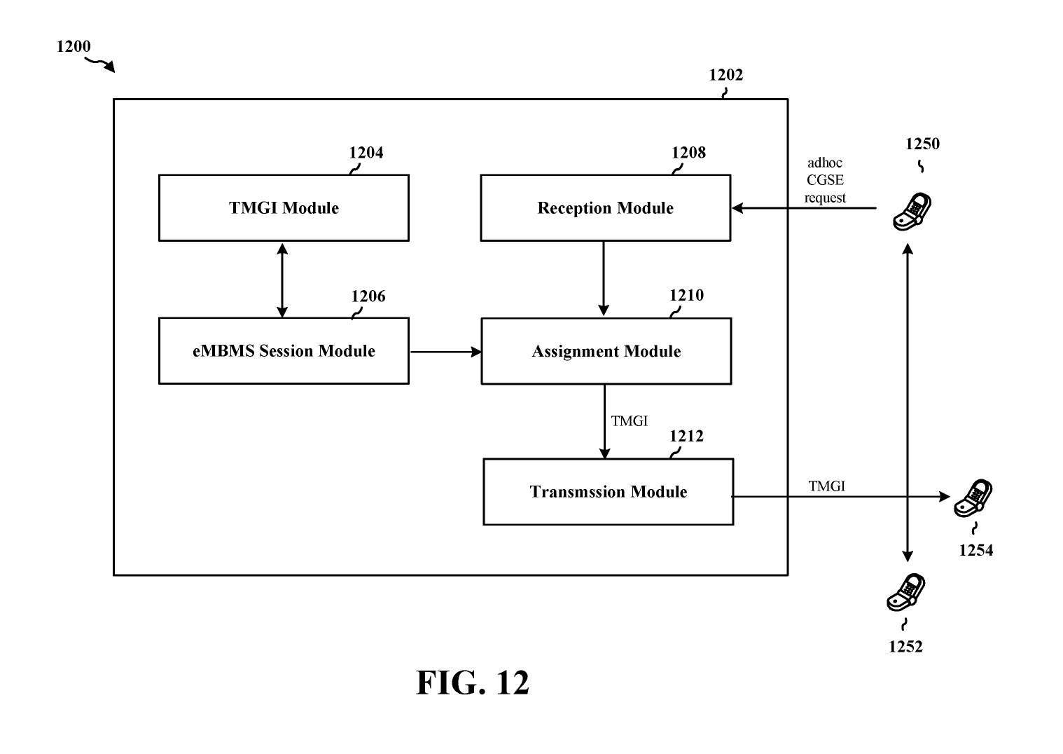

FIG. 12 is a conceptual data flow diagram 1200 illustrating the data flow between different modules/means/components in an exemplary apparatus 1202. The apparatus may be a network element, such as a BM-SC, or it may be a combination of network entities. The apparatus 1202 includes a TMGI module 1204, an eMBMS session module 1206, a reception module 1208, an assignment module 1210, and a transmission module 1212.

The TMGI module 1204 reserves a plurality of TMGIs. The reserved TMGIs are for potential use by adhoc GCSE groups. The eMBMS session module 1206 establishes an eMBMS session in at least one preconfigured MBSFN area, for each of the plurality of reserved TMGIs.

The reception module 1208 receives a request, from an originating UE 1250, to form an adhoc group GCSE group including a plurality of target UEs 1252, 1254 and the originating UE 1250. The assignment module 1210 assigns one of the plurality of TMGIs to the adhoc GCSE group. To this end, the assignment module 1210 may determine the location of the UEs 1250, 1252, 1254, and select the unused one of the plurality of reserved TMGIs based on the location of the UEs. For example, the assignment module 1210 may identify a preconfigured MBSFN area that encompasses the UEs 1250, 1252, 1254, and assign the reserved TMGI that is associated with the identified MBSFN area. The transmission module 1212 sends sending information corresponding to the selected reserved TMGI to the originating UE 1250 and the target UEs 1252, 1254.

The apparatus may include additional modules that perform steps of the aforementioned call flow diagram of FIG. 10 and the algorithm in the flow chart of FIG. 11. As such, steps call flow diagram of FIG. 10 and the algorithm in the flow chart of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

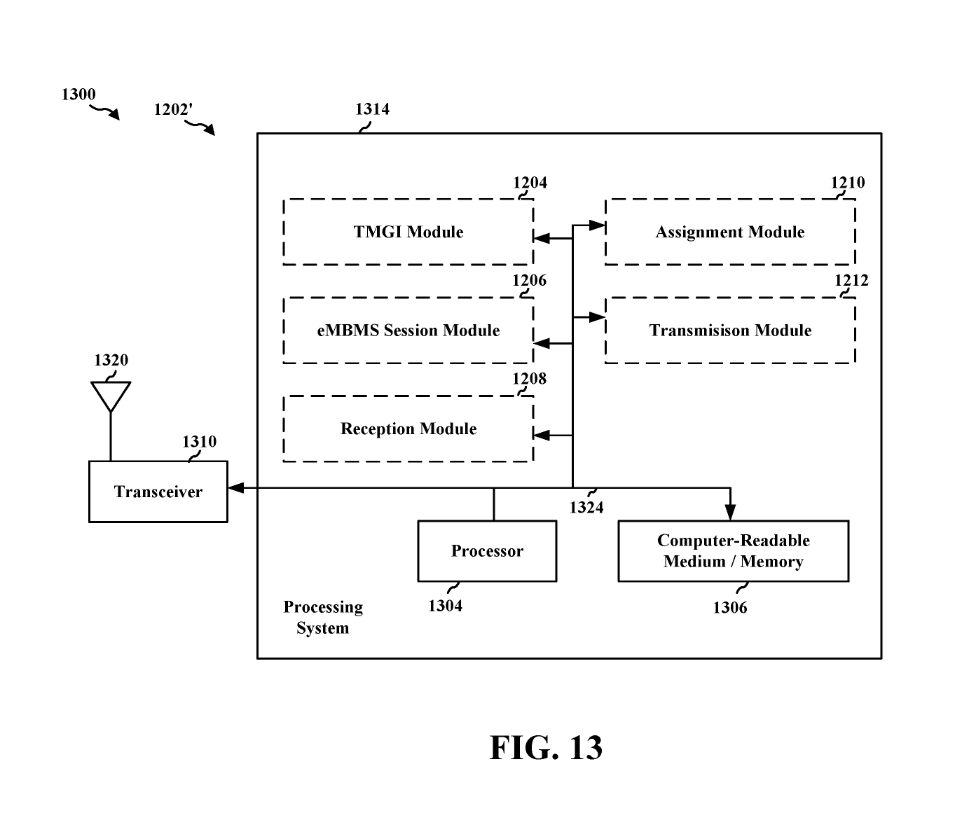

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, and 1212 and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception module 1208. In addition, the transceiver 1310 receives information from the processing system 1314, specifically the transmission module 1212, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system further includes at least one of the modules 1204, 1206, 1208, 1210 and 1212. The modules may be software modules running in the processor 1304, resident/stored in the computer readable medium/memory 1306, one or more hardware modules coupled to the processor 1304, or some combination thereof.

In one configuration, the apparatus 1202/1202′ for wireless communication includes means for reserving a plurality of TMGIs; means for establishing an eMBMS session in at least one preconfigured MBSFN area for each of the plurality of reserved TMGIs; means for receiving a request to form an adhoc GCSE group including a plurality of target UEs; and means for assigning an unused one of the plurality of TMGIs to the adhoc GCSE group. The aforementioned means may be one or more of the aforementioned modules of the apparatus 1202 and/or the processing system 1314 of the apparatus 1202′ configured to perform the functions recited by the aforementioned means.

In one aspect, a network entity for group call communications may include a memory and at least one processor coupled to the memory and configured to: reserve a plurality of TMGIs; establish an eMBMS session in at least one preconfigured MBSFN area for each of the plurality of reserved TMGIs; receive a request to form an adhoc GCSE group including a plurality of target UEs; and assign one of the plurality of TMGIs to the adhoc GCSE group. The processor may be further configured to perform steps of the algorithm in the aforementioned call flow diagram of FIG. 10 and the flow chart of FIG. 11.

In another aspect, a network entity for group call communications may include a computer program product stored on a computer-readable medium and comprising code that when executed on at least one processor causes the at least one processor to: reserve a plurality of TMGIs; establish an eMBMS session in at least one preconfigured MBSFN area for each of the plurality of reserved TMGIs; receive a request to form an adhoc GCSE group including a plurality of target UEs; and assign one of the plurality of TMGIs to the adhoc GCSE group. The code may further cause the at least one processor to perform steps of the algorithm in the aforementioned call flow diagram of FIG. 10 and the flow chart of FIG. 11.

In the above second and third options for reducing latency, the same call up procedure of FIG. 9 applies; however, changes are made to the MCCH configuration so as to reduce the latency of steps 4 and 5. With reference to FIG. 9, at step 4, the network determines the location of each of the target UEs in a GCSE group, and for each location, the network transmits a request for eMBMS session setup. The request includes a group ID and the TMGI for the GCSE group. At step 5, the eMBMS broadcast session is setup in the appropriate MBSFN areas. As noted in table 1, the time to complete steps 4 and 5 may be between 5 and 10 seconds.

In the second option, a new MCCH is introduced specifically for group call services and is used instead of the existing/standard MCCH defined in current 3GPP specifications. This new MCCH is associated with the MBSFN area in which the group call may occur and is characterized by a shorter modification period and repetition period, relative to an existing/standard MCCH. Reductions in these periods reduce the eMBMS session setup delay for the adhoc group.

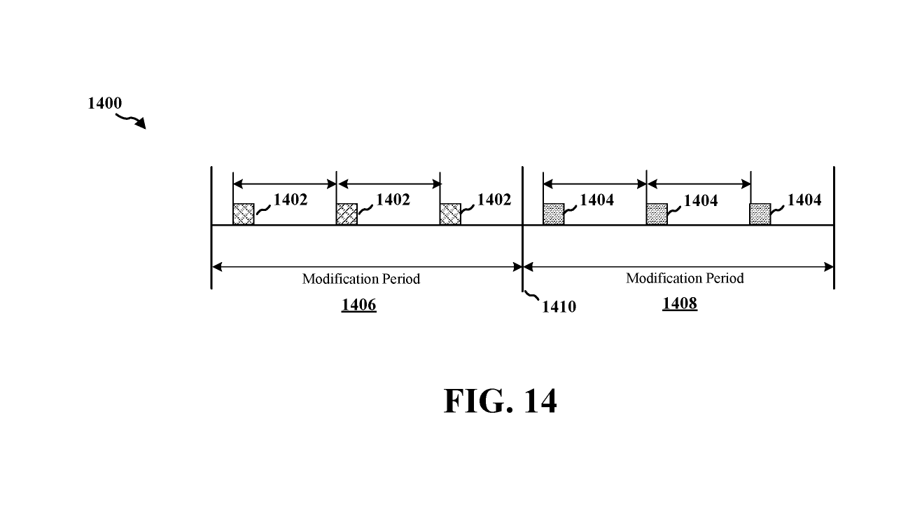

FIG. 14 is an illustration 1400 of a MCCH transmission time line including first and second MCCHs 1402, 1404. The time line also includes first and second modification periods 1406, 1408. A modification period 1406, 1408 corresponds to the time period between changes of MCCH. During the first modification period 1406 of FIG. 14, a first MCCH 1402 is transmitted. At the boundary 1410 between the first modification period 1406 and the second modification period 1408, MCCH changes to a second MCCH 1404. Changes to the MCCH may relate to group call setup. For example, a MCCH may change to include the TMGI and eMBMS session information of the group call. Within a modification period 1404, the current MCCH 1402 will repeat a few times. The repetition period 1404 corresponds to the time between repetitions of the MCCH within the MCCH modification period.

Currently, the modification period for the MCCH may be between 5 and 10 seconds. This means that a change in the MCCH may occur every 5 to 10 seconds. Accordingly, any MCCH changes related to group call setup will take between 5 and 10 seconds.

In the new MCCH, the modification period may be reduced to, for example, 256 msec. A reduction in the modification period results in a reduction in repetition period. With this reduced modification period, the time between changes of MCCH is reduced and changes related to group call setup are communicated faster to the target UEs. The parameters associated with the new MCCH, as specified for example in SIB13, allow information sent via the MCCH to be changed more frequently so that the network is able to add new group call services with less latency, relative to the legacy MCCH.

A new MCCH change notification is introduced to signal whether the new MCCH has changed or not. In order for the group call UE to acquire the new MCCH, SIB13 may add one or more configuration parameters for the new MCCH and/or the new MCCH change notification. These parameters indicate to the group call UE the occurrence of a new MCCH, including when the new MCCH is going to begin, how often the new MCCH may be modified and how often the new MCCH may be repeated within a modification period. Legacy UEs do not recognize the existence of the new MCCH and new MCCH change notification.

Conflicts between existing and the new eMBMS operation with the new MCCH should be avoided. To this end, SIB2 reserves/allocates MBSFN subframes by taking into account both legacy service and potential group call services. For example, if the legacy service will need X MBSFN subframes within a common subframe allocation period, and potential group services will need Y subframes within that common subframe period, SIB2 will allocate X+Y subframes within that period.

Based on this total allocation: legacy MCCH allocates Z MBSFN subframes for each associated physical multicast channel (PMCH) among the first X MBSFN subframes in the common subframe allocation period (commonSF-AllocPeriod), where Z is less than X. The new MCCH allocates MBSFN subframes for each group service among the remaining MBSFN subframes in the common subframe allocation period, where the remaining subframes correspond to (X+Y)−Z. The first PMCH in the new MCCH may start from the subsequent MBSFN subframe identified by a subframe allocation end (sf-AllocEnd) of the last PMCH in legacy MCCH. When the rest of MBSFN subframes in a common subframe allocation period (commonsf-AllocPeriod) are not used by the group call, those subframes can be released by the new MCCH for use by unicast transmissions to avoid resource under utilization. The MSI for the new services will be modified accordingly when the eNB receives the group call data from the MBMS-GW for the corresponding TMGIs.

As mentioned above, the procedure of adhoc group call over eMBMS session for the foregoing second option is the same as the current adhoc group procedure as shown in FIG. 9. Using the new MCCH, the overall delay can be reduced. The following table 3 represents the latency between step 2 and step 12 of the flow call of FIG. 9. The total latency is 746 ms, as opposed to the total latency of 5510 or 10630 ms of the call flow shown in FIG. 9.

TABLE 3

| | | Average | |
|---|---|---|---|
| Step | | Time | |
| Number | Description | (ms) | Comments |
| 2 | Service Request | 140 | 80 ms for random access; 60 ms |
| | Procedures | | for the rest of the steps, |
| | | | including RRC connection |
| | | | setup/service request, security |
| | | | command, RRC |
| | | | reconfiguration. |
| 3 | Group call session | 50? | Sending group call setup |
| | setup | | signaling (e.g., SIP Invite) |
| 4 and 5 | MBMS Session | 256 | New MCCH modification |
| | Setup | | period: use 256 ms as an |
| | | | example |
| 6 | Continue Group call | 50 | SIP messages |
| | setup via EPS bearer | | |
| 7 | Paging and Service | 140 | Paging is not counted. 140 only |
| | Request Procedures | | includes listeners RRC Setup |
| | to targets | | |
| 8 | Continue Group call | 50 | SIP messages etc. |
| | setup | | |
| 9 | USD Update | 0 | In parallel with MMS session |
| | | | setup |
| 10 | MBMS user service | 0 | In parallel with MMS session |
| | registration and | | setup |
| | key request | | |
| 11 | MSP (Read MSI) | 40 | MCH Schedule Period is from |
| | | | 8 frame to 1024 frames |
| 12 | Floor Permit | 20 | Talk Burst Confirm |
| | Total latency | 746 | |

As shown in table 1, with the existing MCCH, the latency of steps 4 and 5 may be 5 to 10 seconds. With new MCCH the same latency may be, for example, between 128 ms and 256 ms. Note that steps 9 and 10 of table 3 are done in parallel with steps 4 and 5; accordingly, the time associated with steps 9 and 10 is zero. The network can issue a USD update (step 9, FIG. 9) and the UE can do the service registration key (step 10, FIG. 9), while the MBMS session is being set up.

In the third option for reducing latency, the MCCH modification period, repetition period and change notification period of existing MCCH are reduced in order to reduce the eMBMS session setup delay for the adhoc group. In this option, existing MCCH with reduced modification period and repetition period is used for group call purposes, while existing MCCH with typical modification period and repetition period is used for legacy users. Accordingly, the MCCH has two portions: one portion is allocated for legacy use, while the other portion is allocated for group call use.

SIB13 indicates two sets of configuration parameters for MCCH, one for legacy use and one for group call use. For legacy use, SIB13 indicates an existing modification period, a repetition period and a change notification period setting. The existing modification period may be between 5 and 10 seconds. For group call use, SIB 13 indicates a reduced MCCH modification period, a repetition period and a change notification period. The reduced MCCH modification period may be, for example, between 256 ms and 128 ms. Legacy UEs look only for the MCCH and MCCH change notification with existing parameter settings. Group call users look for the MCCH and MCCH change notification with both existing and new parameter settings.

To avoid conflict between existing and the new eMBMS operation with the reduced modification period, repetition period and change notification period, the existing MCCH allocates MBSFN subframes by taking into account potential group call services. For example, if MCCH needs to allocate X MBSFN subframes for legacy services, MCCH will allocate X+Y MBSFN subframes, where the additional Y subframes are targeted for potential group call services. The TMGIs used for MCCH to reserve Y MBSFN subframes do not need to be predefined or pre-setup as long as they are not colliding with TMGIs associated with the legacy services belonging to the Y MBSFN subframes. For example, if TMGI1 through TMGI10 are for legacy services, the network may allocate 100 MBSFN subframes for legacy service, with 10 subframes for each TMGI1 through TMGI10. The network may over reserve subframes, e.g., 100 additional subframes for the group call service. The network may use a TMGI dummy to reserve the additional 100 subframes, as long as the TMGI dummy is not colliding with any of the legacy service TMGIs.

Fast MCCH update, which may occur, for example between every 128 to 256 ms, only modifies the MCCH contents related to group call services. At the existing MCCH modification period boundary, e.g., every 5 seconds, the MCCH contents related to all services can be updated. For example, MCCH can allocate a particular PMCH for group call. A fast MCCH update (e.g., every 256 ms) may change the configuration related to a group call PMCH without changing PMCH configurations related to legacy PMCHs. A regular MCCH update (e.g., every 5 seconds) may allow for changes for PMCHs for both group call services and legacy services. For example, if an existing MCCH allocates two PMCHs: a first PMCH is for legacy services, and a second PMCH is for group call services. When a first faster MCCH update occurs (e.g., at 256 ms) only the configuration of the second PMCH for the group call is updated. The configuration of the first PMCH for legacy UEs is not updated. At the 5 second boundary, configurations of both PMCHs are updated.

MBSFN subframes allocated for group call services that are not used by the group call cannot be dynamically released by the existing MCCH because the change to the existing MCCH is every 5 seconds. These unused subframes, may however, be used for unicast transmissions to avoid resource under utilization. The MSI will be modified accordingly when the eNB receives the group call data from MBMS-GW for the correspond TMGIs.

As mentioned above, the procedure of adhoc group call over eMBMS session for the foregoing third option is the same as the current adhoc group procedure as shown in FIG. 9. With a reduction of the modification period of existing MCCH for group call services, the overall delay can be reduced. In the case of a 256 ms modification period for MCCH, the delay estimate is the same as shown in Table 3, wherein the total latency is 746 ms, as opposed to the total latency of 5510 or 10630 ms of FIG. 9.

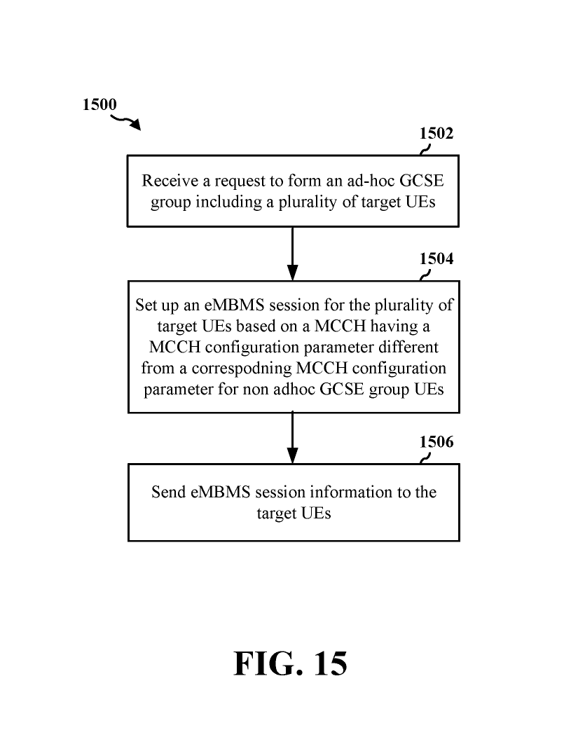

FIG. 15 is a flow chart 1500 of a method of wireless communication. The method may be performed by a network entity, such as a BM-SC, or a combination of network entities. At step 1502, the network entity receives a request to form an adhoc GCSE group including a plurality of target UEs.

At step 1504, the network entity, sets up an eMBMS session for the plurality of target UEs based on a MCCH having a MCCH configuration parameter different from a corresponding MCCH configuration parameter for non adhoc GCSE group UEs. The MCCH configuration parameter different from a corresponding MCCH configuration parameter for non adhoc GCSE group UEs may be one or more of a MCCH modification period, a MCCH repetition period and a MCCH change notification period. The different MCCH configuration parameter may corresponds to at least one of a reduced MCCH modification period, a reduced MCCH repetition period, and a reduced MCCH change notification period.

In one configuration, the eMBMS session is set up by associating to the adhoc group UEs, a new or dedicated MCCH having the at least one different MCCH configuration parameter. This configuration corresponds to option 2 described above. The new MCCH is use for purposes related to the adhoc group set up and is not used for purposes related to legacy UEs.

In another configuration, the eMBMS session is set up associating a first set of MCCH configuration parameters of an existing MCCH with non adhoc group UEs, and associating a second set of MCCH configuration parameters of the existing MCCH with the adhoc group UEs. This configuration corresponds to option 3 described above. The second set of MCCH configuration parameters are reduced relative to the first set of MCCH configuration parameters.

At step 1506, the network entity sends eMBMS session information to the target UEs.

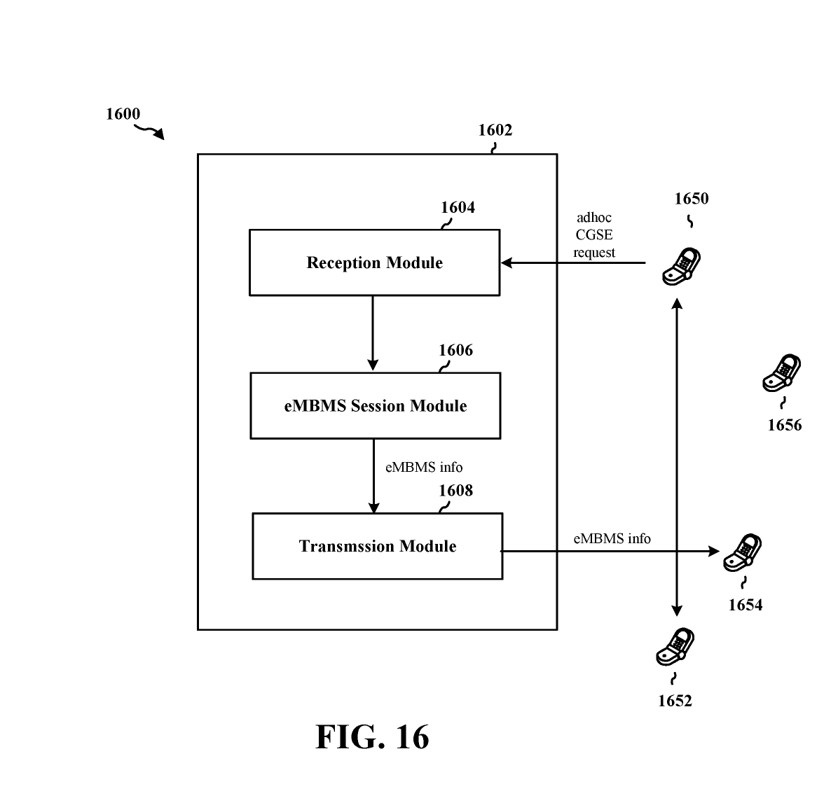

FIG. 16 is a conceptual data flow diagram 1600 illustrating the data flow between different modules/means/components in an exemplary apparatus 1602. The apparatus may be a network entity, such as a BM-SC, or it may be a combination of network entities. The apparatus includes a reception module 1604, an eMBMS session module 1606, and a transmission module 1608.

The reception module 1604 receives a request from an originating UE 1650 to form an adhoc GCSE group including a plurality of target UEs 1652, 1654, including the originating UE 1650. The eMBMS session module 1606 sets up an eMBMS session for the plurality of target UEs 1650, 1652, 1654 based on a MCCH having a MCCH configuration parameter different from a corresponding MCCH configuration parameter for non adhoc GCSE group UEs 1656. The MCCH configuration parameter different from a corresponding MCCH configuration parameter for non adhoc GCSE group UEs may be one or more of a MCCH modification period, a MCCH repetition period and a MCCH change notification period. The different MCCH configuration parameter may corresponds to at least one of a reduced MCCH modification period, a reduced MCCH repetition period, and a reduced MCCH change notification period.

In one configuration, the eMBMS session is set up by associating to the adhoc group UEs 1650, 1652, 1654, a new or dedicated MCCH having the at least one different MCCH configuration parameter. This configuration corresponds to option 2 described above. The new MCCH is use for purposes related to the adhoc group set up and is not used for purposes related to legacy UEs 1656.

In another configuration, the eMBMS session is set up associating a first set of MCCH configuration parameters of an existing MCCH with non adhoc group UEs 1656, and associating a second set of MCCH configuration parameters of the existing MCCH with the adhoc group UEs 1650, 1652, 1654. This configuration corresponds to option 3 described above. The second set of MCCH configuration parameters are reduced relative to the first set of MCCH configuration parameters.

The transmission module 1608 sends eMBMS session information to the adhoc group UEs 1650, 1652, 1654.

The apparatus may include additional modules that perform steps of the aforementioned call flow diagram of FIG. 9 and the algorithm in the aforementioned flow chart of FIG. 15. As such, steps of the aforementioned call flow diagram of FIG. 9 and the algorithm in the aforementioned flow chart of FIG. 15 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

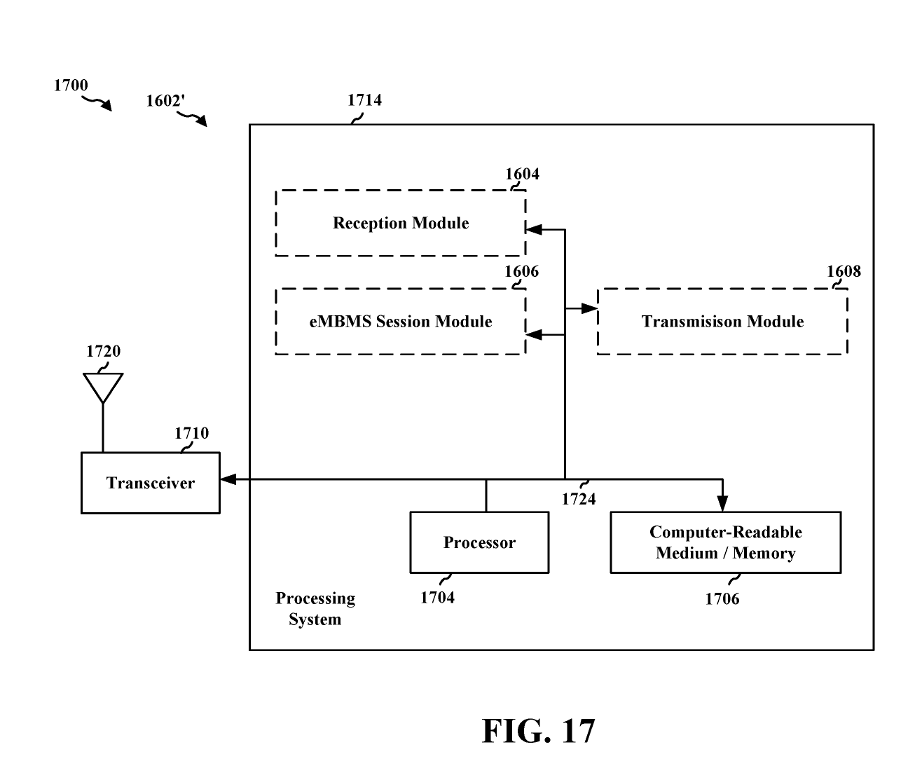

FIG. 17 is a diagram 1700 illustrating an example of a hardware implementation for an apparatus 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware modules, represented by the processor 1704, the modules 1604, 1606, 1608, and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception module 1604. In addition, the transceiver 1710 receives information from the processing system 1714, specifically the transmission module 1608, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system further includes at least one of the modules 1204, 1206, and 1208. The modules may be software modules running in the processor 1704, resident/stored in the computer readable medium/memory 1706, one or more hardware modules coupled to the processor 1704, or some combination thereof.

In one configuration, the apparatus 1602/1602′ for wireless communication includes means for receiving a request to form an adhoc GCSE group including a plurality of target UEs; and means for setting up an eMBMS session for the plurality of target UEs based on a MCCH having a MCCH configuration parameter different from a corresponding MCCH configuration parameter for non adhoc GCSE group UEs. The aforementioned means may be one or more of the aforementioned modules of the apparatus 1502 and/or the processing system 1714 of the apparatus 1502′ configured to perform the functions recited by the aforementioned means.

In one aspect, a network entity for group call communications may include a memory and at least one processor coupled to the memory and configured to: receive a request to form an adhoc GCSE group including a plurality of target UEs; and set up an eMBMS session for the plurality of target UEs based on a MCCH having a MCCH configuration parameter different from a corresponding MCCH configuration parameter for non adhoc GCSE group UEs. The processor may be further configured to perform steps of the algorithm in the aforementioned call flow diagram of FIG. 9 and the flow chart of FIG. 15.

In another aspect, a network entity for group call communications may include a computer program product stored on a computer-readable medium and comprising code that when executed on at least one processor causes the at least one processor to: receive a request to form an adhoc GCSE group including a plurality of target UEs; and set up an eMBMS session for the plurality of target UEs based on a MCCH having a MCCH configuration parameter different from a corresponding MCCH configuration parameter for non adhoc GCSE group UEs. The code may further cause the at least one processor to perform steps of the algorithm in the aforementioned call flow diagram of FIG. 9 and the flow chart of FIG. 15.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of group call communications, comprising:
reserving a plurality of temporary mobile group identities (TMGIs);
for each of the plurality of reserved TMGIs, establishing an evolved multimedia broadcast multicast service (eMBMS) session in at least one preconfigured multicast broadcast single frequency network (MBSFN) area;
receiving a request to form an adhoc group communications service enabler (GCSE) group including a plurality of target UEs; and
assigning one of the plurality of TMGIs to the adhoc GCSE group.

2. The method of claim 1, wherein establishing an eMBMS session in at least one preconfigured MBSFN area comprises configuring at least one eMBMS bearer for the eMBMS session.

3. The method of claim 1, wherein establishing an eMBMS session in at least one preconfigured MBSFN area comprises allocating MBSFN subframes to the eMBMS session.

4. The method of claim 3, wherein establishing an eMBMS session in at least one preconfigured MBSFN area comprises, in the absence of group communication data for the adhoc GCSE group, reallocating MBSFN subframes currently allocated to the eMBMS session corresponding to the assigned TMGI, for unicast transmission.

5. The method of claim 1, wherein establishing an eMBMS session in at least one preconfigured MBSFN area comprises configuring a multicast control channel (MCCH) to include one or more reserved TMGIs and corresponding eMBMS session information.

6. The method of claim 1, wherein assigning comprises;
determining the location of the target UEs, and
selecting the one of the plurality of reserved TMGIs based on the location of the target UEs.

7. The method of claim 1, further comprising sending information corresponding to the assigned TMGI to the target UEs.

8. An apparatus for group call communications, comprising:
means for reserving a plurality of temporary mobile group identities (TMGIs);
means for establishing an evolved multimedia broadcast multicast service (eMBMS) session in at least one preconfigured multicast broadcast single frequency network (MBSFN) area, for each of the plurality of reserved TMGIs;
means for receiving a request to form an adhoc group communications service enabler (GCSE) group including a plurality of target UEs; and
means for assigning one of the plurality of TMGIs to the adhoc GCSE group.

9. The apparatus of claim 8, wherein the means for establishing an eMBMS session in at least one preconfigured MBSFN area is configured to configure at least one eMBMS bearer for the eMBMS session.

10. The apparatus of claim 8, wherein the means for establishing an eMBMS session in at least one preconfigured MBSFN area is configured to allocate MBSFN subframes to the eMBMS session.

11. The apparatus of claim 10, wherein the means for establishing an eMBMS session in at least one preconfigured MBSFN area is configured to, in the absence of group communication data for the adhoc GCSE group, reallocate MBSFN subframes currently allocated to the eMBMS session corresponding to the assigned TMGI, for unicast transmission

12. The apparatus of claim 10, wherein the means for establishing an eMBMS session in at least one preconfigured MBSFN area is configured to configure a multicast control channel (MCCH) to include one or more reserved TMGIs and corresponding eMBMS session information

13. The apparatus of claim 8, wherein the means for assigning is configured to:
determine the location of the target UEs, and
select the one of the plurality of reserved TMGIs based on the location of the target UEs.

14. The apparatus of claim 8, further comprising means for sending information corresponding to the assigned TMGI to the target UEs.

15. A method of group call communication, comprising:
receiving a request to form an adhoc group communications service enabler (GCSE) group including a plurality of target UEs; and
setting up an evolved multimedia broadcast multicast service (eMBMS) session for the plurality of target UEs based on a multicast control channel (MCCH) having a MCCH configuration parameter different from a corresponding MCCH configuration parameter for non adhoc GCSE group UEs.

16. The method of claim 15, wherein the MCCH configuration parameter different from a corresponding parameter for non adhoc GCSE group UEs comprises at least one of a MCCH modification period, a MCCH repetition period and a MCCH change notification period.

17. The method of claim 16, wherein the different MCCH configuration parameter corresponds to at least one of a reduced MCCH modification period, a reduced MCCH repetition period, and a reduced MCCH change notification period.

18. The method of claim 15, wherein setting up an eMBMS session comprises associating to the adhoc group UEs, a dedicated MCCH having the at least one different MCCH configuration parameter.

19. The method of claim 15, wherein setting up an eMBMS session comprises:
associating a first set of MCCH configuration parameters of an existing MCCH with non adhoc group UEs; and
associating a second set of MCCH configuration parameters of the existing MCCH with the adhoc group UEs.

20. The method of claim 19, wherein the second set of MCCH configuration parameters are reduced relative to the first set of MCCH configuration parameters.

21. A apparatus of group call communication, comprising:
means for receiving a request to form an adhoc group communications service enabler (GCSE) group including a plurality of target UEs; and
means for setting up an evolved multimedia broadcast multicast service (eMBMS) session for the plurality of target UEs based on a multicast control channel (MCCH) having a MCCH configuration parameter different from a corresponding MCCH configuration parameter for non adhoc GCSE group UEs.

22. The apparatus of claim 21, wherein the MCCH configuration parameter different from a corresponding parameter for non adhoc GCSE group UEs comprises at least one of a MCCH modification period, a MCCH repetition period and a MCCH change notification period.

23. The apparatus of claim 22, wherein the different MCCH configuration parameter corresponds to at least one of a reduced MCCH modification period, a reduced MCCH repetition period, and a reduced MCCH change notification period.

24. The apparatus of claim 21, wherein the means for setting up an eMBMS session is configured to associate to the adhoc group UEs, a dedicated MCCH having the at least one different MCCH configuration parameter.

25. The apparatus of claim 21, wherein means for setting up an eMBMS session is configured to:
associate a first set of MCCH configuration parameters of an existing MCCH with non adhoc group UEs; and
associate a second set of MCCH configuration parameters of the existing MCCH with the adhoc group UEs.

26. The apparatus of claim 25, wherein the second set of MCCH configuration parameters are reduced relative to the first set of MCCH configuration parameters.
